(19) United States
(12) Patent Application Publication
(10) Pub. No.: US 2011/0276541 A1
(43) Pub. Date: Nov. 10, 2011

(54) Information processing system

(75) Inventor: Yohei Ono, Kanagawa (JP)

(73) Assignee: Ricoh Company, Ltd., Tokyo (JP)

(21) Appl. No.: 13/064,892

(22) Filed: Apr. 25, 2011

(30) Foreign Application Priority Data
May 10, 2010 (JP) 2010-108187

(51) Int. Cl. G06F 17/30

(52) U.S. Cl. 707/687; 707/E17.007

(57) ABSTRACT

An information processing system for recording operational information in a log includes a log generating unit configured to generate the log in such a manner that a conversion target character string included in the log is recognizable; a log converting unit configured to convert the conversion target character string to an irrecoverable and unique character string; a log outputting unit configured to output the log including the converted character string; and a log collecting unit configured to collect the output log.

### CROSS-REFERENCE TO RELATED APPLICATIONS

This patent application is based upon and claims the benefit of priority of Japanese Patent Application No. 2010-108187 filed on May 10, 2010 the entire contents of which are incorporated herein by reference.

### BACKGROUND OF THE INVENTION

1. Field of the Invention

The present invention is generally directed to a technology for collecting a log from an information processing apparatus, such as a server and an image forming apparatus.

2. Description of the Related Art

In a computer system, collecting and analyzing various types of logs which record operational information of the system is an important investigation technology used at the time of system failures.

Known methods of collecting logs include acquisition from a target information processing apparatus via a network and acquisition by connecting a recording medium, such as a USB memory, to a target information processing apparatus; however, such methods rarely allow on-site log analyses, and it is necessary to transfer logs from a system installed at the site to an operator at a maintenance station in one way or another.

On the other hand, it is often the case that a log includes personal information, such as a user ID, a user name, a terminal IP address, and confidential information. It is therefore desired to prevent information leaks at the time of acquisition and transfer of logs as well as information leaks from maintenance stations.

Known technologies to prevent information leaks include encryption of personal information and confidential information, use of turned (switched) letters, and prohibition of output of such information (see Patent Documents 1 and 2, for example).

Patent Document 1 discloses a method of preventing unnecessary information leaks caused by reference to a system log by setting a role according to the purpose for analyzing the system log and encrypting the system log in such a manner that only a person given the role can refer to the system log.

Patent Document 2 discloses a technology for, in order to provide a log of a computer system, on which maintenance is to be performed, to a maintenance provider with due consideration to management of customer information, allowing customers to select disclosable information and information to be confidential and outputting only the disclosable information to a log.

### [Patent Document 1] Japanese Laid-open Patent Application Publication No. 2007-200059

### [Patent Document 2] Japanese Laid-open Patent Application Publication No. 2007-265296

As described above, the methods of encrypting personal information and confidential information, using turned letters and prohibiting output of such information have been conventionally used to prevent information leaks; however, the following problems have been pointed out.

As for the technology of encrypting personal information and confidential information, a maintenance operator decrypts the personal information and confidential information when analyzing a log. Thus, the operator is able to view such information, which may result in information leaks if the subsequent management is lenient.

On the other hand, in the case of using turned letters for personal information and confidential information or prohibiting output of such information, a process cannot be tracked based on a log, which interferes with the analytical work.

### SUMMARY OF THE INVENTION

Accordingly, embodiments of the present invention may provide a novel and useful information processing system solving one or more of the problems discussed above.

In view of the above-described conventional problems, the embodiments of the present invention may provide an information processing system capable of preventing information leaks while eliminating interference with the analytical work.

One aspect of the present invention may be to provide an information processing system for recording operational information in a log. The information processing system includes a log generating unit configured to generate the log in such a manner that a conversion target character string included in the log is recognizable; a log converting unit configured to convert the conversion target character string to an irrecoverable and unique character string; a log outputting unit configured to output the log including the converted character string; and a log collecting unit configured to collect the output log.

Another aspect of the present invention is a processing method applied to an information processing system for recording operational information in a log. The processing method includes a log generating step of generating the log in such a manner that a conversion target character string included in the log is recognizable; a log converting step of converting the conversion target character string to an irrecoverable and unique character string; a log outputting step of outputting the log including the converted character string; and a log collecting step of collecting the output log.

Yet another aspect of the present invention is a non-transitory computer-readable storage medium storing a computer-executable program. The computer-executable program causes an information processing system for recording operational information in a log to perform a processing method which includes a log generating step of generating the log in such a manner that a conversion target character string included in the log is recognizable; a log converting step of converting the conversion target character string to an irrecoverable and unique character string; a log outputting step of outputting the log including the converted character string; and a log collecting step of collecting the output log.

Additional objects and advantages of the embodiments will be set forth in part in the description which follows, and in part may be obvious from the description, or may be learned by practice of the invention. The object and advantages of the invention may be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 shows an example of a system structure according to a first embodiment of the present invention;

FIG. 2 shows an example of a system structure according to a second embodiment of the present invention;

FIG. 3 shows an example of a system structure according to a third embodiment of the present invention;

FIG. 4 is a flowchart showing an exemplified procedure of setting an anonymization target item;

FIGS. 5A and 5B show examples of item data;

FIG. 6 shows an example of an anonymization target selection screen;

FIGS. 7A to 7C show data examples of anonymization target items;

FIGS. 8A to 8C are flowcharts showing exemplified procedures according to embodiments of the present invention;

FIG. 9 is a flowchart showing an exemplified procedure of log conversion;

FIG. 10 shows an example of a log before and after the log conversion;

FIG. 11 shows an example of a system structure according to a fourth embodiment of the present invention;

FIG. 12 is a sequence diagram illustrating an exemplified procedure according to the fourth embodiment;

FIG. 13 shows an example of an anonymization target selection screen;

FIG. 14 shows an example of a user information table;

FIG. 15 shows an example of items to be actual anonymization targets;

FIG. 16 shows an example of an anonymization level table; and

FIG. 17 shows an example of a user information table showing correspondence between user IDs and anonymization levels.

### DETAILED DESCRIPTION OF THE PREFERRED EMBODIMENTS

Embodiments that describe the best mode for carrying out the present disclosures are explained next.

### First to Third Embodiments

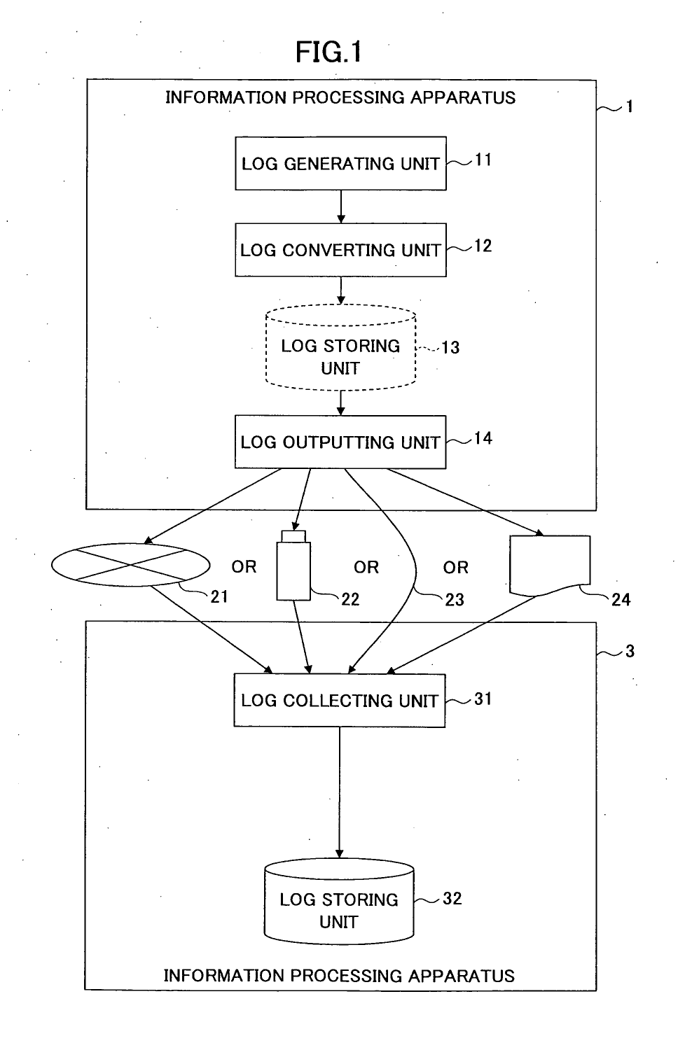

FIG. 1 shows an example of a system structure according to a first embodiment of the present invention.

As shown in FIG. 1, an information processing apparatus 1 from which a log is collected includes a log generating unit 11, a log converting unit 12, a log storing unit 13 and a log outputting unit 14.

The log generating unit 11 has a function of outputting a log in a predetermined format, which log records operational information of the system. Log generation may be performed each time an event for which a log is to be recorded occurs, or may be collectively performed based on accumulated data that describe events. In order to later perform conversion of an anonymization target character string (i.e., a conversion target character string) included in an anonymization target item (a conversion target item), a log needs to be generated in such a manner that the anonymization target character string is recognizable, and the means for performing log conversion needs to comprehend the recognizing method. The recognizing method is described later in detail.

The log converting unit 12 has a function of converting an anonymization target character string included in a log generated by the log generating unit 11 to an irrecoverable and unique character string. The conversion operation is described later in detail.

The log storing unit 13 has a function of storing a converted log output from the log converting unit 12 in a memory or a storage area of a disc. Note that the log storing unit 13 is not an essential component and may be omitted.

The log outputting unit 14 has a function of reading the converted log from the log storing unit 13 at a predetermined timing and outputting it externally. In the case when no log storing unit 13 is provided, the log outputting unit 14 outputs externally the converted log output from the log converting unit 12. A log may be output as data via a network 21, a memory device (such as a USB memory) 22 or a direct connection 23, or as a printout on paper 24. Note that log data do not have to be in the form of a file and may be a data fragment displayed on a browser or the like.

On the other hand, an information processing apparatus 3 which performs log collection includes a log collecting unit 31 and a log storing unit 32. Note that the information processing apparatus 3 does not have to be a sophisticated apparatus such as a personal computer, and may be a memory device such as a USB memory. In this case, when the information processing apparatus 3 is a memory device, a log is collected from the information processing apparatus 1 through the direct connection 23.

The log collecting unit 31 has a function of inputting a log, which has been output from the log outputting unit 14 of the information processing apparatus 1 as data via the network 21, the memory device 22 or the direct connection 23, or as a printout on paper 24. In the case of inputting a log using a printout on paper 24, an image scanner and an optical character reading function are used, or the log is manually input.

The log storing unit 32 has a function of storing a log collected by the log collecting unit 31 in a memory or a storage area of a disk.

Note that the above description is given of the case where the information processing apparatus 1 which is a log-collection target (i.e., an apparatus from which a log is collected) and the information processing apparatus 3 which performs the log collection are separately provided; however, these apparatuses may be structured into a single information processing apparatus.

With the structure described above, the log conversion is performed according to the log generation, and information before the anonymizing treatment is not stored even in the case where a log is stored, thus strengthening the prevention against information leaks. Note however that the anonymization target character string is stored in a converted format, and therefore if an anonymization target item is changed during the operation, the change cannot be reflected in contents of an already-generated log.

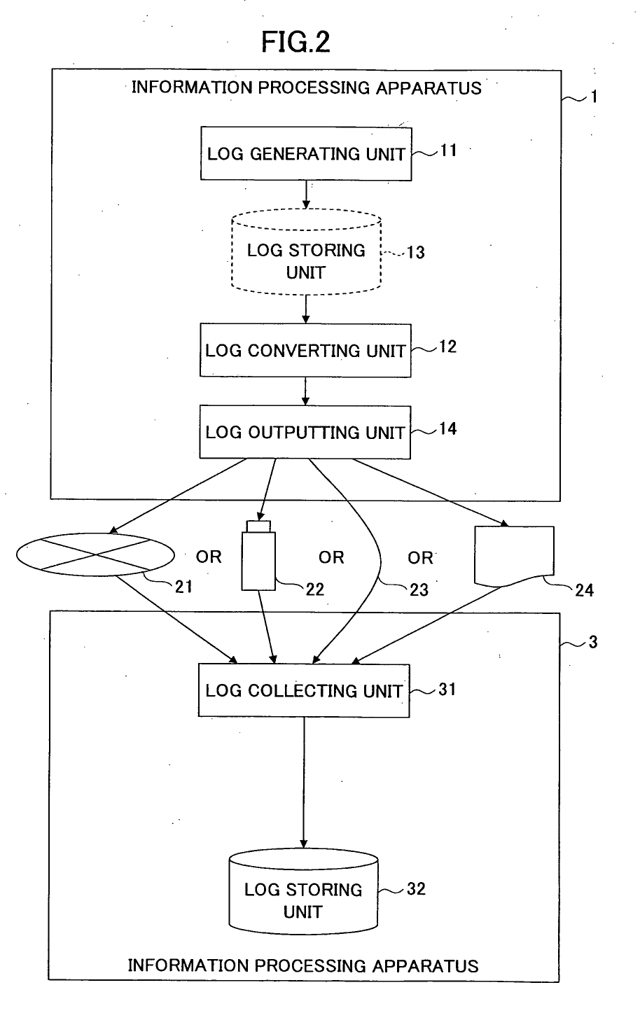

FIG. 2 shows an example of a system structure according to a second embodiment of the present invention. Compared to the first embodiment shown in FIG. 1, the log converting unit 12 is provided in the subsequent stage of the log storing unit 13. In the case where the log storing unit 13 is omitted, the structure of the second embodiment is the same as that of the first embodiment of FIG. 1.

The log storing unit 13 has a function of storing a log generated by the log generating unit 11 in a memory or a storage area of a disk. Note that the log storing unit 13 is not an essential component and may be omitted.

The log converting unit 12 has a function of reading a log from the log storing unit 13 and converting an anonymization target character string included in the log to an irrecoverable and unique character string. In the case where the log storing unit 13 is not provided, the log converting unit 12 converts an anonymization target character string included in a log generated by the log generating unit 11 to an irrecoverable and unique character string. The conversion operation is described later in detail.

The remaining functional components are the same as those described in the first embodiment. The information processing apparatus 1 which is a log-collection target and the information processing apparatus 3 for performing the log collection may be structured into a single information processing apparatus.

With the structure described above, the log conversion is performed according to the log output, and therefore information before the anonymizing treatment is temporarily stored in a log storing area in the case where a log is stored. However, if an anonymization target item is set at the timing of the log output, it is possible to output log contents in accordance with the set anonymization target item.

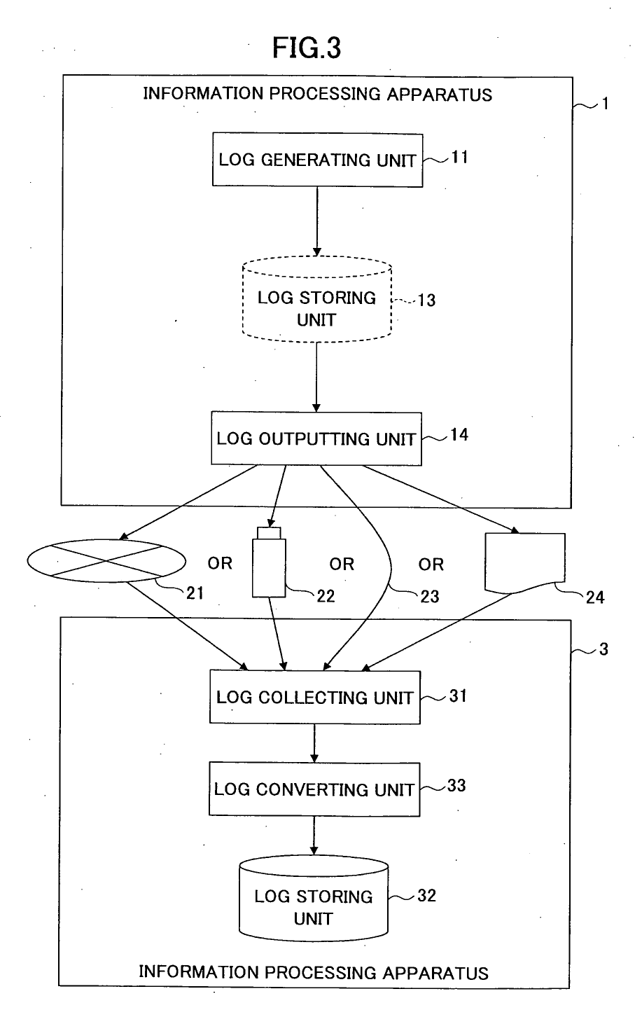

FIG. 3 shows an example of a system structure according to a third embodiment of the present invention. Compared to the second embodiment shown in FIG. 2, the log converting unit 12 is removed from the information processing apparatus 1 which is a log-collection target and, instead, a log converting unit 33 is provided in the stage subsequent to the log collecting unit 31 in the information processing apparatus 3 which performs the log collection.

The log outputting unit 14 has a function of reading a converted log from the log storing unit 13 at a predetermined timing and outputting it externally. In the case when no log storing unit 13 is provided, the log outputting unit 14 outputs externally the log generated by the log generating unit 11.

The log converting unit 33 has a function of converting an anonymization target character string included in a log collected by the log collecting unit 31 to an irrecoverable and unique character string. The conversion operation is described later in detail.

The log storing unit 32 has a function of storing a log converted by the log converting unit 33 in a memory or a storage area of a disk.

The remaining functional components are the same as those described in the second embodiment. The information processing apparatus 1 which is a log-collection target and the information processing apparatus 3 for performing the log collection may be structured into a single information processing apparatus.

With the structure described above, the log conversion is performed after the log collection, and therefore information before the anonymizing treatment is temporarily stored in a log storing area and the log collecting side. However, if an anonymization target item is set at the timing of the log collection, it is possible to acquire log contents in accordance with the set anonymization target item.

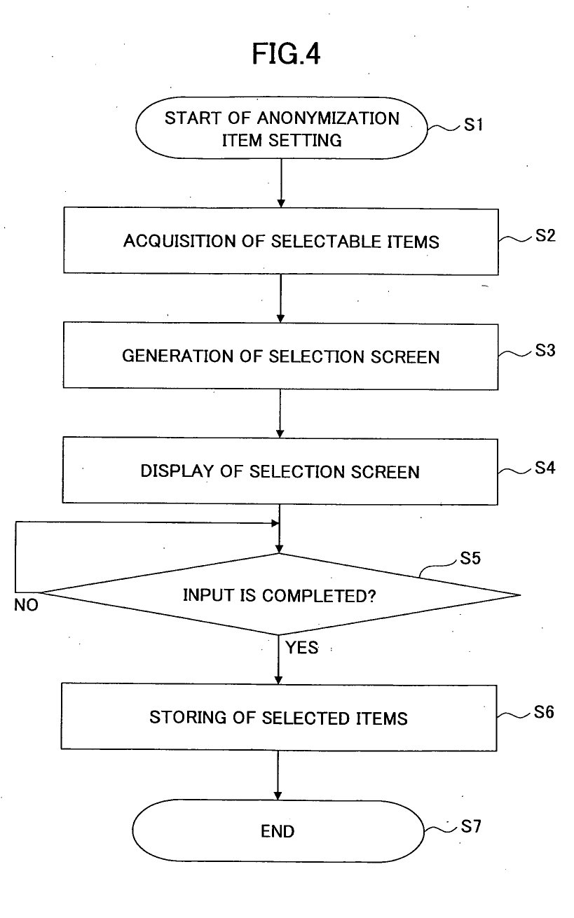

FIG. 4 is a flowchart showing an exemplified procedure of setting an anonymization target item according to the embodiment described above. To set an anonymization target item is not essential, and having fewer anonymization target items is preferable in terms of the log readability. In addition, anonymization target items may be different among system managers, and it is therefore preferable that anonymization target items be configured to be selectable so that only the minimum necessary items are assigned as anonymization targets.

With the structures of FIGS. 1 and 2, the procedure of setting an anonymization target item is performed by the information processing apparatus 1. With the structure of FIG. 3, the procedure is performed by the information processing apparatus 3. In addition, the user operation to proceed with this procedure may be performed using either of the information processing apparatuses 1 and 3, or may be performed remotely from another information processing apparatus via a network.

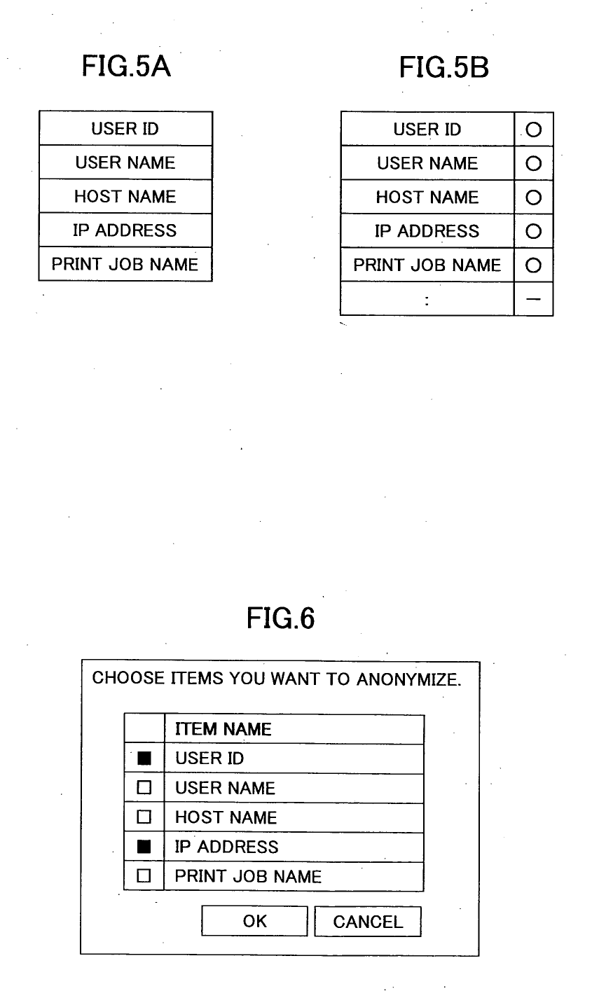

As shown in FIG. 4, the procedure of setting an anonymization target is started by a user's operation (Step S1), and selectable items are acquired (Step S2). The acquired selectable items may be maintained in the form of a list as shown in FIG. 5A, or may be maintained in a format where a flag “∘” is assigned to each selectable item among all items included in a log as shown in FIG. 5B. Note that the data format is not limited to those shown in FIGS. 5A and 5B.

Referring back to FIG. 4, an anonymization target item selection screen is generated based on the acquired selectable items (Step S3), and then displayed (Step S4). FIG. 6 shows an example of the anonymization target selection screen, and on the screen, a check box is provided for each anonymization target item to let the user select anonymization target items. In FIG. 6, items “user ID” and “IP address” are selected.

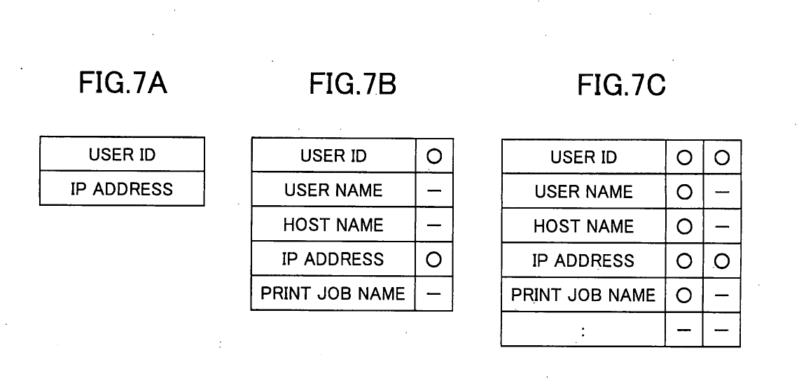

Referring back to FIG. 4, whether the input is completed is determined based on pressing the “OK” button or the like (Step S5). When the input is determined to be completed (Step S5: Yes), the selected items are stored as anonymization target items (Step S6) and the procedure is finished (Step S7). FIGS. 7A-7C show data examples of the anonymization target items. FIG. 7A shows a storing format in which only the selected items are stored in the form of a list; FIG. 7B shows a storing format in which a flag for indicating an anonymization target item has been assigned to each of the selected items among the selectable items (FIG. 5A); and FIG. 7C shows a storing format in which the flag for indicating an anonymization target item has been assigned to all the items (FIG. 5B) included in a log. Note that the data format is not limited to those shown in FIGS. 7A to 7C. Assume that a condition (i.e., an extraction condition) for extracting an anonymization target character string of each anonymization target item is stored in association with the anonymization target item.

The above describes the case in which one set of anonymization target items is assigned for the information processing apparatus 1 which is a log-collection target; however, a different set of anonymization target items may be assigned with respect to each user. In this case, anonymization target items are stored in association with the users (using a user ID or the like).

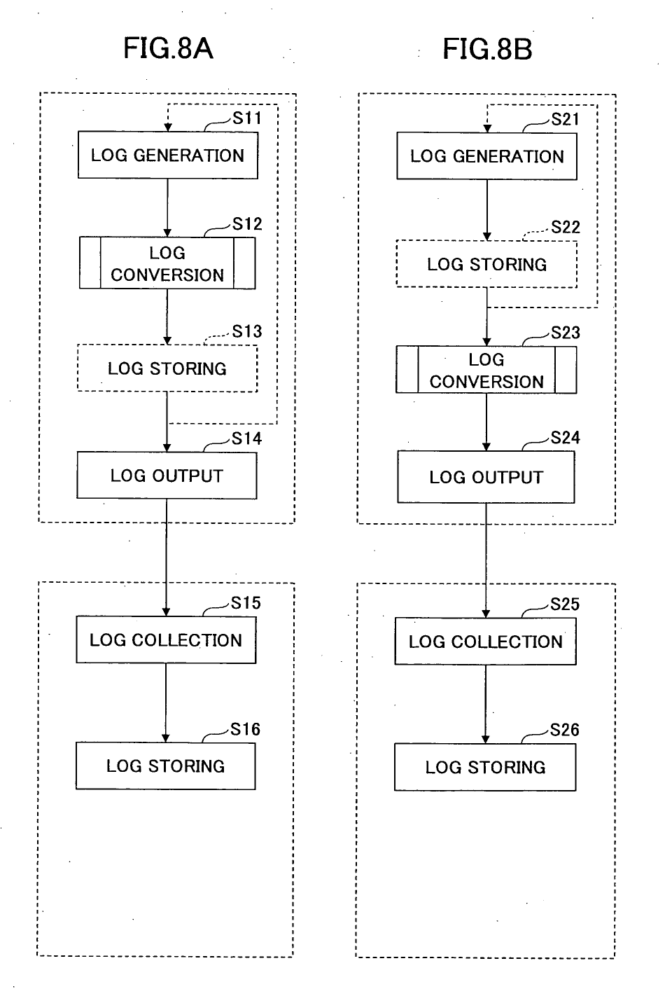

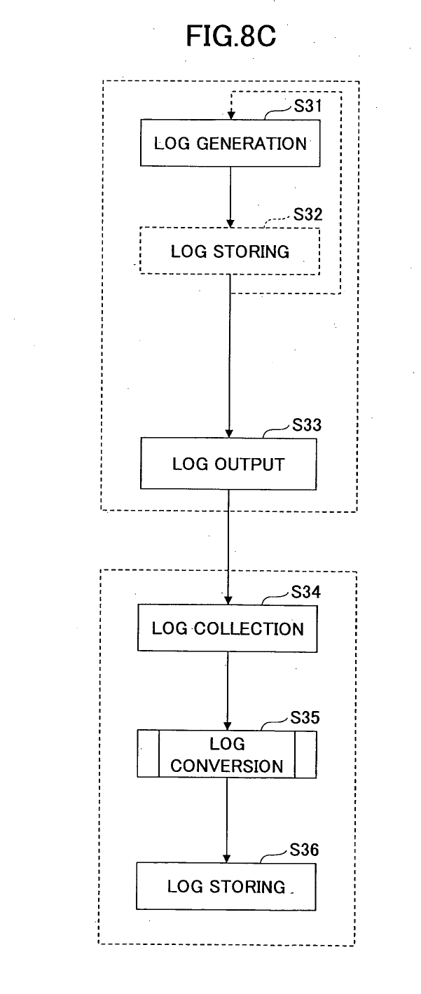

FIGS. 8A to 8C are flowcharts showing exemplified procedures according to the embodiments described above. FIG. 8A corresponds to the first embodiment shown in FIG. 1; FIG. 8B corresponds to the second embodiment shown in FIG. 2; and FIG. 8C corresponds to the third embodiment shown in FIG. 3. These procedures differ in the timing of performing the log conversion operation.

With reference to FIG. 8A, in the information processing apparatus 1, log generation (Step S11), log conversion (Step S12), log storing (Step S13) and log output (Step S14) are sequentially performed. In the case when the log storing (Step S13) is performed (i.e., in the case when logs are not collectively generated), the log storing (Step S13) is followed by the next log generation (Step S11) and the subsequent processes are repeated. In the case when the log storing (Step S13) is not performed, the log output (Step S14) is performed at the same time as the log conversion (Step S12).

On the other hand, in the information processing apparatus 3, log collection (Step S15) and log storing (Step 16) are sequentially performed.

With reference to FIG. 8B, in the information processing apparatus 1, log generation (Step S21), log storing (Step S22), log conversion (Step S23) and log output (Step S24) are sequentially performed. In the case when the log storing (Step S22) is performed (i.e., in the case when logs are not collectively generated), the log storing (Step S22) is followed by the next log generation (Step S21) and the subsequent processes are repeated. In the case when the log storing (Step S22) is not performed, the log conversion (Step S23) and the log output (Step S24) are performed at the same time as the log generation (Step S21).

On the other hand, in the information processing apparatus 3, log collection (Step S25) and log storing (Step 26) are sequentially performed.

With reference to FIG. 8C, in the information processing apparatus 1, log generation (Step S31), log storing (Step S32) and log output (Step S33) are sequentially performed. In the case when the log storing (Step S32) is performed (i.e., in the case when logs are not collectively generated), the log storing (Step S32) is followed by the next log generation (Step S31) and the subsequent processes are repeated. In the case when the log storing (Step S32) is not performed, the log output (Step S33) is performed at the same time as the log generation (Step S31).

On the other hand, in the information processing apparatus 3, log collection (Step S34), log conversion (Step S35) and log storing (Step S36) are sequentially performed.

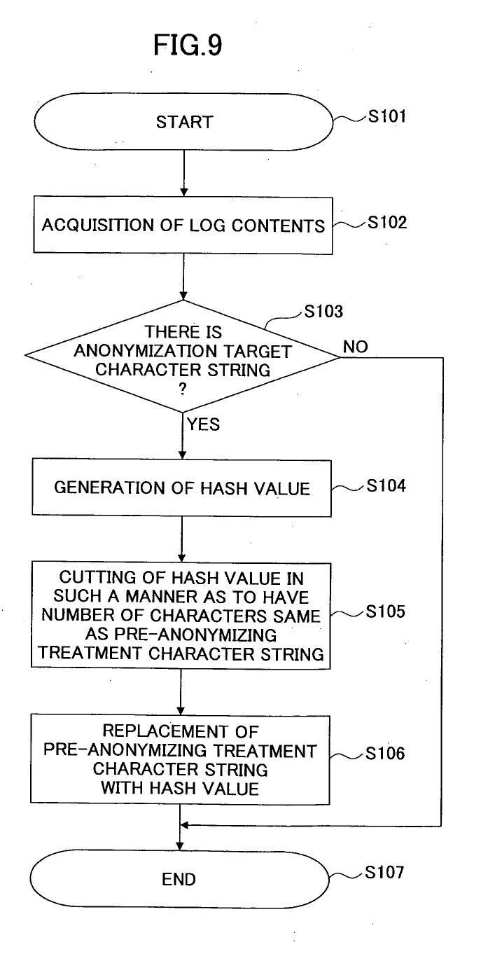

FIG. 9 is a flowchart showing an exemplified procedure of the log conversion (Step S12 of FIG. 8A; Step S23 of FIG. 8B; and Step S35 of FIG. 8C). Here, the following describes a case in which hash conversion is used for the conversion operation to an irrecoverable and unique character string; however, as long as the conversion to an irrecoverable and unique character string can be achieved, other conversion methods may be used.

With reference to FIG. 9, after the procedure is started (Step S101), log contents are acquired (Step S102) and then whether an anonymization target character string is included is determined (Step S103). This determination is made by acquiring extraction conditions of the data of the anonymization target items shown in FIG. 7 and searching the log based on the extraction conditions. In the case where anonymization target items are set for each user, a corresponding user ID or the like obtained from data of the log is used to acquire the anonymization target items.

As an extraction condition, the following, for example, may be considered: in the case when the anonymization target item is “user ID”, for example, a range following a particular character string, such as “#USERID#”, and enclosed in square brackets “[” and “]” is assigned as an anonymization target character string. The particular character string may be something meaningful such as “#USERID#”, or may be something coded such as “#1#”. In this case, if square brackets “[” and “]” are included in the anonymization target character string, an escape method or the like should be employed. Other examples of extraction conditions include a method of outputting the log in a comma separated value (CSV) format and determining what number item from the beginning is to be an anonymization target character string, and a method of assigning a part matched by a regular expression (which is a technique of specifying a combination pattern of character strings using special symbols) as an anonymization target character string.

Referring back to FIG. 9, in the case when it is determined that an anonymization target character string is not included (Step S103: No), the procedure is finished (Step S107).

On the other hand, if it is determined that an anonymization target character string is included (Step S103: Yes), a hash conversion is performed on the anonymization target character string to generate a hash value (Step S104). To generate a hash value, a general hash function, such as MD5 and SHA, may be used, or a unique algorithm may be used. The hash value calculated here does not have to be rigorous, and it is sufficient as long as the following two conditions are satisfied: the character string before the anonymizing treatment cannot be recovered; and the hash value is unique and can therefore be distinguished from other character strings after the anonymizing treatment.

Next, the hash value is cut to have the number of characters the same as the anonymization target character string before the anonymizing treatment (hereinafter, referred to as the “pre-anonymizing treatment character string”) (Step S105). It seems to be often the case that a general hash value after the hash conversion has a considerably larger number of characters compared to the pre-anonymizing treatment character string. Specifically, if a 5-digit character string of “user1”, for example, is converted by the MD5 hash function, which is a simple hash function, a 32-digit character string “24c9e15e52afc47c225b757e7bee1f9d” is generated. A large number of characters reduces readability of the log, and also increases the quantity of the log, which results in difficulty in handling the log. As mentioned above, since what is important here is not that the generated hash value is rigorous but that the pre-anonymizing treatment character string cannot be recovered and the hash value can be distinguished from other character strings after the anonymizing treatment, it is preferable to perform some manipulation, for example, cutting the hash value to have the number of characters the same as the pre-anonymizing treatment character string as in Step S105. In this case, the conversion result of “user1” is “24c9e”.

Next, the pre-anonymizing treatment character string is replaced with the cut hash value (hereinafter, referred to as the “post-anonymizing treatment character string” (Step S106), and the procedure is finished (Step S107).

Note that, according to the above conversion operation, there is a possibility that different anonymization target character strings may be converted to the same post-anonymizing treatment character string; however, it is less likely to have the same post-anonymizing treatment character strings within a single section requiring log analysis, and there is therefore considered to be no problem for the analysis.

On the other hand, although the reverse conversion directly from the post-anonymizing treatment character string to the pre-anonymizing treatment character string is impossible, in the case when the anonymization target character string is fixed, as is the case of an IP address, matching the pre-anonymizing treatment character string with the post-anonymizing treatment character string is relatively easy, and therefore, the pre-anonymizing treatment character string can be guessed. If such a case is expected, the following approach may be taken:
(1) providing an entry field for a magic code (an arbitrary character string) on the anonymization target selection screen (FIG. 6);
(2) setting, in the magic code entry field, a magic code which a log analyst does not know; and
(3) in the hash value generation (Step S104 of FIG. 9) of the log conversion operation, generating a hash value of a character string which is formed by adding the magic code to the anonymization target character string.

Note that there is no change in the process of cutting the hash value (Step S105 of FIG. 9), and the generated hash value is cut to have the number of characters the same as the anonymization target character string (not the number of characters of the character string formed by adding the magic code to the anonymization target character string). For example, in the case where a magic code “magic” is set for an anonymization target character string “192.168.001.001”, “192.168.001.001magic” is hashed. Then, since a resultant hash value is cut to have the number of characters of “192.168.001.001”, i.e., 15, the post-anonymizing treatment character string becomes “4bcb0e75ecf247d”. This makes clear the number of characters of the pre-anonymizing treatment character string but hides the number of the digits of the magic code, thus making it substantially impossible to guess the pre-anonymizing treatment character string.

By setting a magic code as described above, it becomes difficult for the log analyst to guess the pre-anonymizing treatment character string. Note however that in the case where it is necessary to acquire logs from different information processing apparatuses and analyze the logs, the same magic code needs to be used.

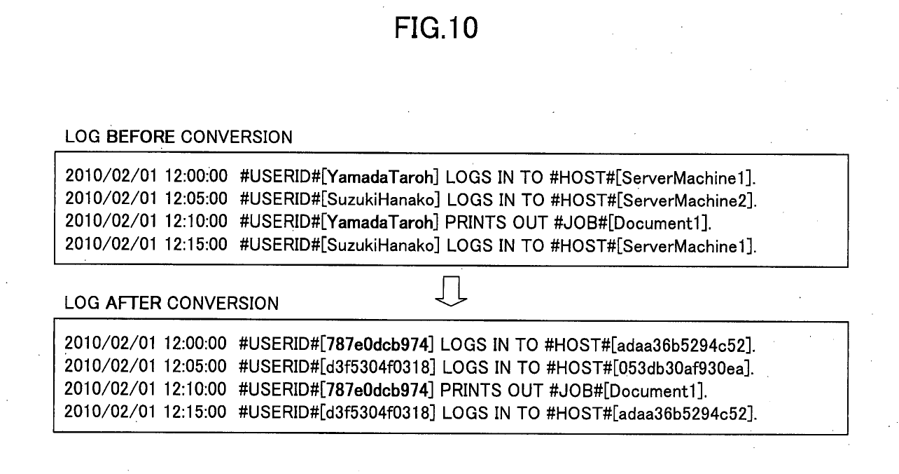

FIG. 10 shows an example of a log before and after the log conversion. In this case, the “user ID” and “host name” are assigned as anonymization target items, and “#USERID#” and “#HOST#” are used as specific character strings for determining anonymization target character strings.

“#USERID#[YamadaTaroh]” before the conversion is converted to “#USERID#[787e0dcb974]”, “#HOST#[ServerMachine1]” before the conversion is converted to “#HOST#[adaa36b5294c52]”, and “#HOST#[ServerMachine2]” before the conversion is converted to “#HOST#[053 db30af930ea]”. In the converted log, the anonymization target character strings are output in an irrecoverable manner; however, it can be seen that the user on the first line who logged in is the same as the user on the third line who printed out a document, thus allowing the log analyst to track processes when analyzing the log and facilitating smooth analytical work.

### Fourth Embodiment

At companies, for example, it is sometimes the case that different anonymization target items are assigned for different departments when personal information and confidential information included in a log are anonymized. For example, assume that a first information processing apparatus has a secure setting with many anonymization target items while a second information processing apparatus has a smaller number of anonymization target items. Under such a condition, there would be no problem if users of each of the departments use only an information processing apparatus installed in their department. However, there may be an occasion that a user usually using the first information processing apparatus having the secure setting uses the second information processing apparatus installed in a different department. In this case, by comparing logs collected from both the information processing apparatuses, personal information and confidential information of the user can be identified. Specifically, assume that “user ID”, “user name”, “host name”, “IP address” and “print job name” are assigned as anonymization target items in the first information processing apparatus, and “user ID” and “IP address” are assigned as anonymization target items in the second information processing apparatus. Assume further that a user uses both the information processing apparatuses, and logs are then collected from these information processing apparatuses. Since the user ID of a single user is always converted to the same character string, the user name and host name anonymized on the first information processing apparatus that the user usually uses become revealed by extracting log data of a character string (post-anonymizing treatment character string) of the same user ID from the logs of both information processing apparatuses. Even if the user uses the second information processing apparatus only once, log data can be identified by associating the user name of the user on the first information processing apparatus and on the second information processing apparatus.

In order to solve this problem, a fourth embodiment of the present invention is capable of setting anonymization target items with respect to each user.

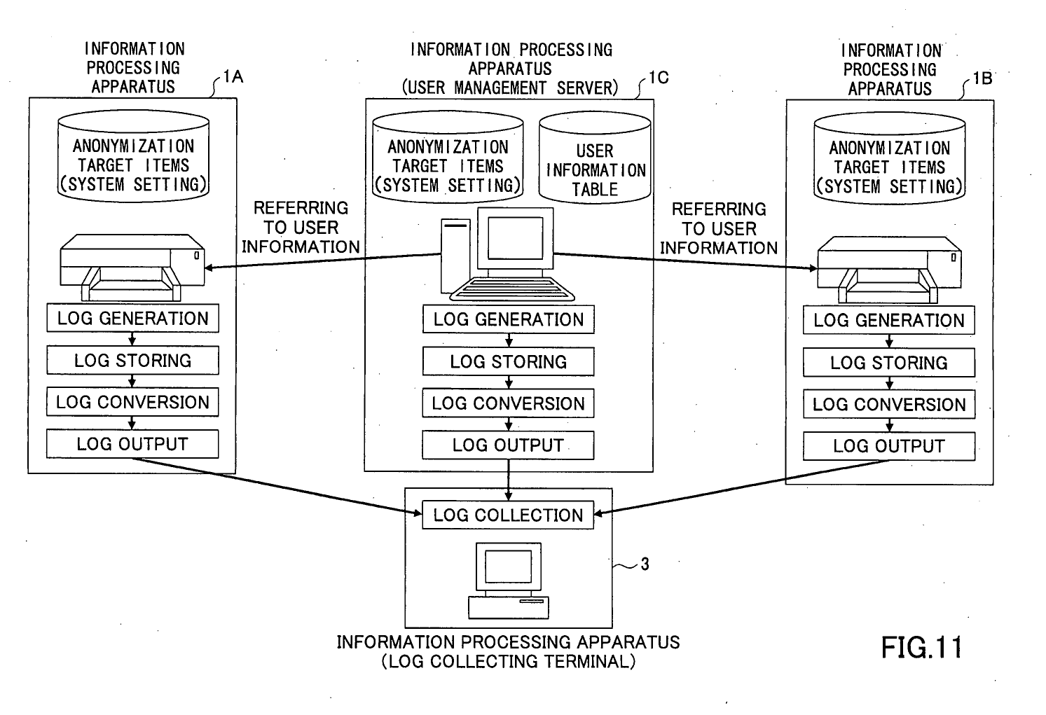

FIG. 11 shows an example of a system structure according to the fourth embodiment.

As shown in FIG. 11, information processing apparatuses 1A, 1B and 1C are log-collection targets, and the information processing apparatus 3 performs log collection. Each of the information processing apparatuses 1A, 1B and 1C, which are the log-collection targets, stores anonymization target items set by the procedure of FIG. 4 as a system setting. Note that the log collection of FIG. 11 is performed in the same manner as those of FIG. 2 and FIG. 8B (i.e., the log conversion operation is performed at the same time as the log output); however, another procedure may be adopted. The information processing apparatus 10 is a log-collection target but also functions as a user management server, and is provided with a user information table for storing anonymization target items with respect to each user.

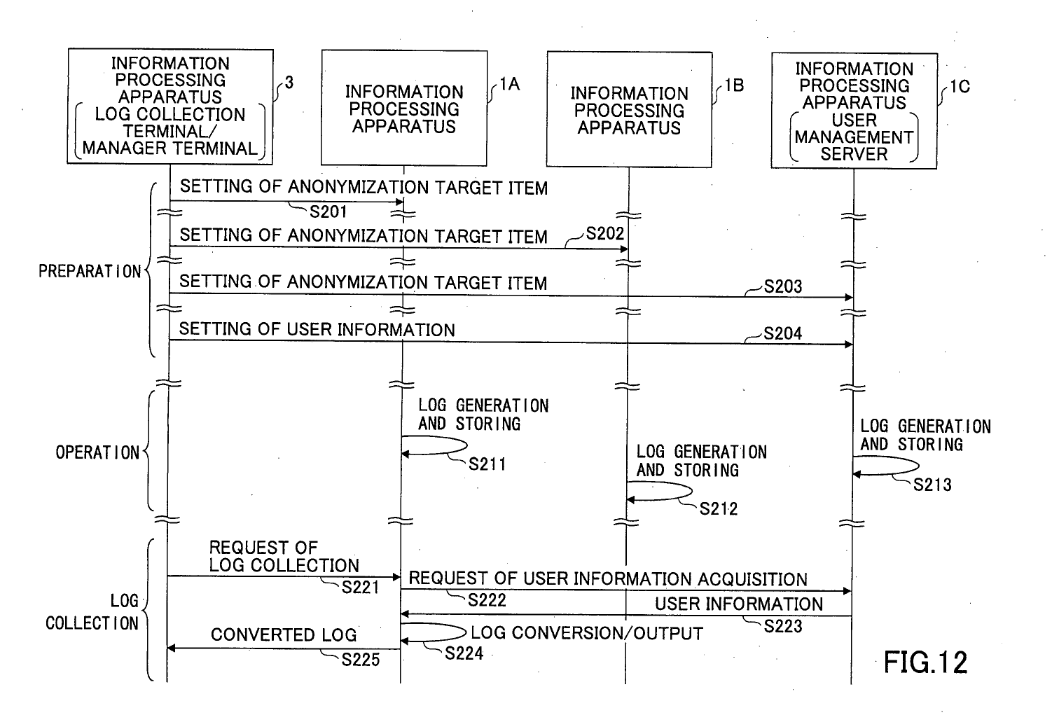

FIG. 12 is a sequence diagram illustrating an exemplified procedure according to the fourth embodiment.

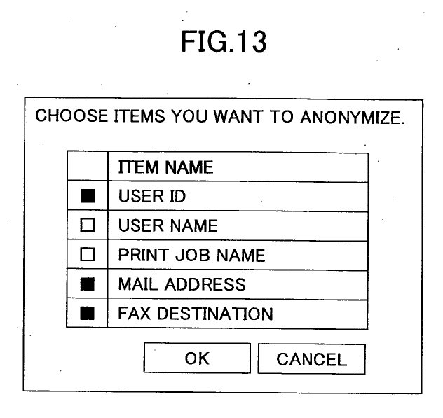

With reference to FIG. 12, as a preparation, the information processing apparatus 3 sets anonymization target items for each of the information processing apparatuses 1A, 1B and 1C (Steps S201 to S203). The setting order is arbitrary. The setting of the anonymization target items is performed in the same manner as illustrated in FIGS. 4 to 7C. Here, one or more anonymization target items are selected from “user ID”, “user name”, “print job name”, “mail address” and “fax destination” on an anonymization target item setting screen shown in FIG. 13.

In addition, the information processing apparatus 3 sets user information in the information processing apparatus 10 (Step S204). The setting of the user information may be performed before the setting of the anonymization target items (Steps 201 to 203).

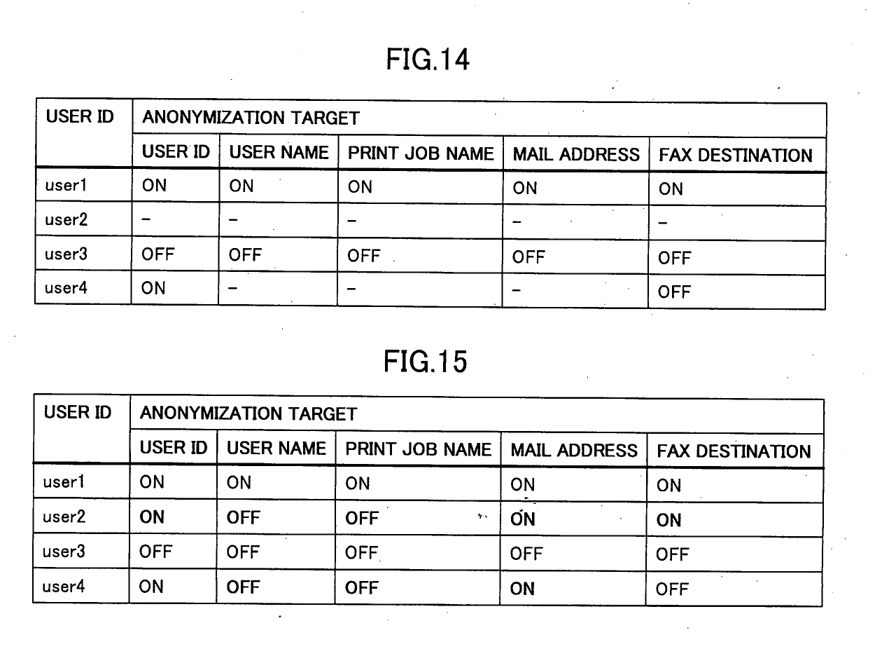

FIG. 14 shows an example of the user information table, in which “ON” (i.e., assigned as an anonymization target), “OFF” (not assigned as an anonymization target) or “-” (not specified) is registered for the items “user ID”, “user name”, “print job name”, “mail address” and “fax destination” with respect to each user ID. With reference to FIG. 14, “user1” has a secure setting with all items being assigned as anonymization targets; “user2” has a setting with no specified anonymization target items; “user3” has an insecure setting with all items being not assigned as anonymization targets; and “user4” has a setting including all three types of registrations for the items.

Note that here the information processing apparatus 3 performs the above-described setting processes on each of the information processing apparatuses 1A, 1B and 1C; however, these processes may be performed by another manager terminal, or may be performed by the information processing apparatuses 1A, 1B and 1C themselves.

Referring back to FIG. 12, in the subsequent operation, the information processing apparatuses 1A, 1B and 10 respectively generate and store logs (Steps S211 to S213). The order and number of times of the log generation and storing are arbitrary.

FIG. 12 shows the subsequent log collection only for the information processing apparatus 1A; however, the log collection is also performed in the same manner for the remaining information processing apparatuses 1B and 10.

First, when the information processing apparatus 3 requests the information processing apparatus 1A to perform log collection (Step S221), the information processing apparatus 1A requests the information processing apparatus 10 to provide user information (Step S222). In response, the information processing apparatus 10 passes the user information on to the information processing apparatus 1A (Step S223).

The information processing apparatus 1A performs log conversion and output (Step S224). In the log conversion, the information processing apparatus 1A cross-checks the anonymization target items (system setting) with the user information to thereby decide actual anonymization target items. That is, in the case when the registered setting for an anonymization target item in the user information is explicitly assigned (i.e., “ON” or “OFF”), the information processing apparatus 1A complies with the setting. On the other hand, in the case when the registered setting for an anonymization target item in the user information is not explicitly assigned (“-”), the information processing apparatus 1A complies with the system setting. FIG. 15 shows an example of items to be actual anonymization targets. In FIG. 15, the anonymization setting for “user1” is a result of “user ID”, “mail address” and “fax destination” being selected as the anonymization target items (system setting) in the information processing apparatus 1A, as shown in FIG. 13, and the user information being set as shown in FIG. 14. In FIG. 15, anonymization settings indicated by boldface are decided by following the system setting since the registered settings are not explicitly specified.

Referring back to FIG. 12, the information processing apparatus 1A provides the converted log to the information processing apparatus 3 (Step S225).

Note that in the user information of FIG. 14, anonymization target items are set with respective to each user; however, the anonymization level may be set for each user, instead. The anonymization level may be set based on classification according to office locations, corporate positions, companies or the like.

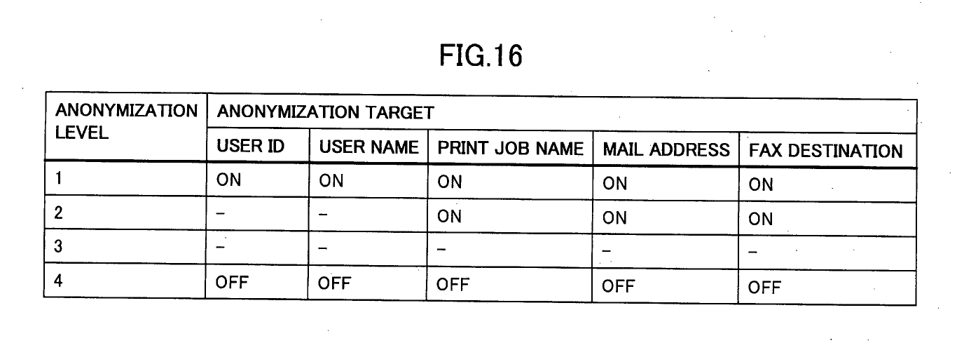

FIG. 16 shows an example of an anonymization level table, in which the anonymization levels have anonymization settings for the respective anonymization target items. An anonymization level can be created arbitrarily, and anonymization target items can be set for each of the anonymization levels. The anonymization level table is stored in the information processing apparatus 10 functioning as the user management server.

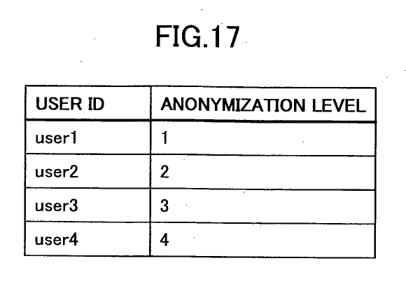

FIG. 17 shows an example of a user information table showing correspondence between the user IDs and anonymization levels, and the user information table stores setting information of the anonymization levels for the respective users.

Combining the settings in the anonymization level table of FIG. 16 and the settings in the user information table of FIG. 17 results in contents the same as the settings in the user information table of FIG. 14. Adopting the setting formats of FIGS. 16 and 17 improves the management efficiency compared to the setting format of FIG. 14, in which anonymization settings are specified for each user.

### CONCLUSION

As has been described above, according to the embodiments of the present invention, by converting personal information and confidential information included in a log to irrecoverable and unique character strings, it is possible to prevent information leaks since the personal information and confidential information are excluded from the log. At the same time, the conversion generates unique character strings, which allows a log analyst to track processes, and thus eliminates interference with the analytical work.

That is, since the conversion method employed by the embodiments of the present invention generates an irrecoverable character string, it is possible to prevent leaks of anonymized personal information and confidential information. In addition, the character string generated by the conversion method is unique, which allows tracking of the anonymized information. For example, even if there are logs indicating operations under the same user ID on different times and dates, it is possible to track the operations made by a corresponding user since the post-anonymizing treatment character string generated from a single user ID is always output as the same character string. In addition, even if the types of software and systems are completely different from each other, causing the log output process to be performed in the same manner enables log tracking over the different software and systems.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An information processing system for recording operational information in a log, the information processing system comprising:
a log generating unit configured to generate the log in such a manner that a conversion target character string included in the log is recognizable;
a log converting unit configured to convert the conversion target character string to an irrecoverable and unique character string;
a log outputting unit configured to output the log including the converted character string; and
a log collecting unit configured to collect the output log.

2. The information processing system as claimed in claim 1, further comprising a conversion target setting unit configured to set a conversion target item which includes the conversion target character string.

3. The information processing system as claimed in claim 1, further comprising a first conversion target setting unit configured to set a conversion target item, which includes the conversion target character string, with respect to an information processing apparatus to be a log collection target; and a second conversion target setting unit configured to set a conversion target item, which includes the conversion target character string, with respect to a user, wherein when performing the conversion, the log converting unit determines an actually used conversion target item by giving priority to the conversion target item set with respect to the user over the conversion target item set with respect to the information processing apparatus.

4. A method applied to an information processing system for recording operational information in a log, the method comprising:
a log generating step of generating the log in such a manner that a conversion target character string included in the log is recognizable;
a log converting step of converting the conversion target character string to an irrecoverable and unique character string;
a log outputting step of outputting the log including the converted character string; and
a log collecting step of collecting the output log.

5. The method as claimed in claim 4, further comprising a conversion target setting step of setting a conversion target item which includes the conversion target character string.

6. The method as claimed in claim 4, further comprising a first conversion target setting step of setting a conversion target item, which includes the conversion target character string, with respect to an information processing apparatus to be a log collection target; and a second conversion target setting step of setting a conversion target item, which includes the conversion target character string, with respect to a user, wherein when the conversion is performed in the log converting step, an actually used conversion target item is determined by giving priority to the conversion target item set with respect to the user over the conversion target item set with respect to the information processing apparatus.

7. A non-transitory computer-readable storage medium storing a computer-executable program, the computer-executable program causing an information processing system to perform a method of recording operational information in a log,
wherein the method includes:
a log generating step of generating the log in such a manner that a conversion target character string included in the log is recognizable;
a log converting step of converting the conversion target character string to an irrecoverable and unique character string;
a log outputting step of outputting the log including the converted character string; and
a log collecting step of collecting the output log.

8. The non-transitory computer-readable storage medium as claimed in claim 7, wherein the method further includes a conversion target setting step of setting a conversion target item which includes the conversion target character string.

9. The non-transitory computer-readable storage medium as claimed in claim 7, wherein the method further includes a first conversion target setting step of setting a conversion target item, which includes the conversion target character string, with respect to an information processing apparatus to be a log collection target; and a second conversion target setting step of setting a conversion target item, which includes the conversion target character string, with respect to a user, and when the conversion is performed in the log converting step, an actually used conversion target item is determined by giving priority to the conversion target item set with respect to the user over the conversion target item set with respect to the information processing apparatus.
